(19) United States
(12) Patent Application Publication
(10) Pub. No.: US 2025/0217692 A1
(43) Pub. Date: Jul. 3, 2025

(54) Adaptive Quantum Instruction Scheduler for Quantum Parallel Processing Units

(71) Applicant: Advanced Micro Devices, Inc., Santa Clara, CA (US)

(72) Inventors: DaZheng WANG, Shanghai (CN); Jie ZHANG, Orlando, FL (US); Zhenyu XU, Orlando, FL (US)

(73) Assignee: Advanced Micro Devices, Inc., Santa Clara, CA (US)

(21) Appl. No.: 18/398,755

(22) Filed: Dec. 28, 2023

(51) Int. Cl. G06N 10/80

(52) U.S. Cl. CPC G06N 10/80

(57) ABSTRACT

A quantum computing device includes a plurality of quantum parallel processing units (Q-PPUs) configured to execute a set of quantum instructions of a quantum application program. The quantum computing device includes an adaptive quantum instruction scheduler to dynamically distribute the set of quantum instructions to the plurality of Q-PPUs based, at least in part, upon a measured probability of a desired result of executing the set of quantum instructions of the quantum application program and a decoherence time of a qubit.

### BACKGROUND

In classical computing, binary digits (also known as bits) are the basic units of information. Today's classical computers use billions of transistors, each of which can represent one of two discrete states of a bit (i.e., “0” or “1”) to perform calculations. Generally, as the number of transistors increases, so does the number of simultaneous calculations a classical computer can perform. Classical computers can quickly and efficiently solve many problems. However, solutions to certain problems, such as problems related to encryption, biological system modeling, optimization, and data analysis, can be determined more efficiently using a completely different type of computing known as a quantum computing.

Quantum computers perform computations by manipulating the states of quantum bits (also known as qubits) to execute quantum algorithms to solve problems, such as those mentioned above. While a classical bit can be in a state representative of 0 or a state representative of 1, a qubit can represent both states 0 and 1 at the same time. This is a quantum mechanical phenomenon known as superposition. Superposition is a key property of quantum systems and serves as the foundation for many quantum algorithms, including Shor's algorithm for factoring large numbers and Grover's algorithm for unstructured searching. Superposition enables the potential for exponential speedup in certain computations and plays a central role in harnessing the power of quantum computing.

### BRIEF DESCRIPTION OF THE DRAWINGS

FIG. 1 depicts a non-limiting example operating environment in which an adaptive quantum instruction scheduler distributes quantum instructions to a plurality of quantum parallel processing units of a quantum computing device.

FIG. 2 depicts a non-limiting example micro-scheduler sequence performed by a micro-scheduler of the adaptive quantum instruction scheduler.

FIG. 3 depicts a Q-PPU grid as a non-limiting example logical configuration of the plurality of Q-PPUs of the quantum computing device.

FIG. 4 depicts a method for scheduling quantum instructions in a course-grained way by a macro-scheduler of the adaptive quantum instruction scheduler and in a fine-grained way by the micro-scheduler of the adaptive quantum instruction scheduler.

### DETAILED DESCRIPTION

### Overview

Quantum computing relies on quantum mechanical phenomena such as superposition and entanglement to perform computations. Superposition results from the wave-like nature of quantum particles and is a fundamental concept in quantum mechanics. Superposition is described mathematically using complex numbers and represented by a linear combination of basis states. For a single qubit, the superposition is expressed as: |ψ [symbol] =α|0 [symbol] +β|1 [symbol] , where |0 [symbol] and |1 [symbol] represent the two basis states, and a and β are complex probability amplitudes that determine the probability of measuring the qubit in the respective states. These probabilities are given by the squared magnitudes of the amplitudes, |α|² and |β|², which should sum to 1. The power of superposition in quantum computing lies in the ability to manipulate and process information encoded in these complex quantum states. By applying quantum gates and operations, it becomes possible to perform computations on multiple potential outcomes simultaneously. For example, if two qubits are in superposition, a quantum system is in a superposition of four possible states: |ψ [symbol] =α|00 [symbol] +β|01 [symbol] +γ|10 [symbol] +δ|11 [symbol] , where α, β, γ, and δ are probability amplitudes. This allows quantum algorithms to perform parallel computations and explore multiple solutions simultaneously, providing a potential advantage over classical computation for certain computing tasks.

When a measurement is performed on a qubit in superposition, the superposition “collapses” into one of the basis states with a probability given by the squared magnitude of the corresponding probability amplitude. The act of measurement resolves the superposition into a definite classical outcome. Superposition is a key property of quantum systems and serves as the foundation for many quantum algorithms, including Shor's algorithm for factoring large numbers and Grover's algorithm for unstructured searching. Superposition enables the potential for exponential speedup in certain computations and plays a central role in harnessing the power of quantum computing.

Quantum computing utilizes another quantum mechanics phenomenon called quantum entanglement. When particles are entangled, the state of one particle is intrinsically connected to the state of the other particles. This connection persists regardless of the distance between the particles and instantaneously influences the states of the entangled particles when a measurement is taken.

Quantum measurement is a fundamental process in quantum mechanics where the state of a quantum system is observed or determined through an interaction with a quantum measurement device. Quantum measurement devices extract information from quantum systems and collapse the superposition of qubits into definite classical states. In quantum mechanics, the state of a system is described by a wavefunction or a quantum state vector. A measurement corresponds to an operation that determines a specific observable property of the qubits in the system, such as position, momentum, spin, or energy. When a measurement is performed, the qubits undergo a state change, transitioning from a superposition of possible states to a definite eigenstate of the measured observable property.

Decoherence is another quantum phenomenon and refers to the loss of quantum coherence that results in the deterioration of quantum states. Decoherence occurs when a quantum system interacts with its surrounding environment, leading to the “collapse” of any superposition of quantum states and the emergence of classical behavior. Qubits are highly susceptible to decoherence. When qubits interact with the environment, such as through unintended interactions with particles, electromagnetic fields, or environmental changes (e.g., temperature fluctuations), the delicate quantum properties of the qubits can be disrupted. Decoherence causes the loss of phase relationships between different states of a quantum system, making it difficult to maintain and manipulate the fragile quantum information stored in qubits. As a result, the quantum computation becomes increasingly susceptible to errors and noise, reducing the effectiveness of quantum algorithms.

Grover's algorithm is a quantum search algorithm that allows one to search an unsorted database or find a specific item in a large set of possibilities faster than classical algorithms. Grover's algorithm operates by applying a sequence of operations on a quantum computer to amplify the probability of finding the desired solution. The algorithm begins with an equal superposition of all possible solutions. Then, the algorithm uses a series of quantum operations to “mark” the desired solution and “amplify” its probability.

Grover's algorithm incorporates three main components: an oracle operator, a diffusion operator, and a fixed number of iterations (commonly referred to as “Grover iterations”). The oracle operator accelerates searches for a desired item within a search space, such as an unsorted database. The oracle operator helps identify a specific marked item or multiple marked items in the search space. The oracle operator acts as a black box function that takes an input and produces an output based on whether the input corresponds to a marked item or not. Oracle operators are typically implemented as quantum gates or unitary transformations. The specific implementation of an oracle operator depends on the problem being solved and the encoding of the search space. The oracle operator works on the quantum state of the search space, manipulating the amplitudes of the marked and unmarked items. The diffusion operator amplifies the amplitudes of all states except for the desired solution. The diffusion operator reflects the amplitude across the average. For each Grover iteration, the algorithm repeats the steps performed by the oracle and diffusion operators a fixed number of times to increase the probability of finding the desired solution. By iteratively applying the oracle and diffusion operators, Grover's algorithm concentrates the amplitude on the desired solution, allowing the desired solution to be measured with a relatively high probability.

Grover's algorithm can be implemented to solve a wide range of problems. By way of example and not limitation, Grover's algorithm is utilized to improve graphics rendering algorithms, such as ray tracing and supersampling. Ray tracing is a graphics rendering algorithm used to realistically calculate visible and invisible rays of lights, such as to provide accurate lighting effects in video games and other digital visual media. Supersampling is a graphics rendering algorithm that enables sampling of images at a higher resolution than a target output display allows and then averaging down to the true pixel level. The averaged values contain more information about the image than if the sampling was performed at the resolution of the target output display. Supersampling improves image quality, in part by reducing aliasing effects in images.

In one or more scenarios where quantum computing is used with ray tracing, a quantum circuit traces multiple rays per layer of circuit depth at a same time by storing the rays in a superposition. Tracing multiple rays at the same time is difficult for classical ray tracing algorithms due to exponential explosion, which is the rapid and exponential increase in the number of possibilities or combinations as the size or complexity of a problem grows.

With supersampling, a quantum circuit performs supersampling to find the average of the subpixel colors with a certain probability. This achieves a better rendering result than a classical Monte Carlo estimation, which is used to approximate unknown quantities or calculate numerical results using random sampling and statistical analysis. Using a quantum circuit for supersampling also provides a lower average pixel error for the same number of subpixel evaluations.

A problem with quantum circuits is that multiple Grover iterations are required to amplify a marked item so that measuring a final state of a qubit returns the correct item with the expected probability. The iteration steps are determined by the number of qubits in the quantum computer. For graphics rendering methods, such as ray tracing and supersampling, the numbers of primitives and pixels increase with the size of the quantum circuit. This is detrimental to the fragile nature of qubits that lose information due to noise, resulting in the loss of quantum coherence (i.e., relatively short decoherence time). Thus, the probability of achieving correct results decrease as the size of quantum circuit increases.

With quantum computing applied for graphics rendering algorithms like ray tracing and supersampling, a hybrid classical and quantum circuit can obtain a quadratic speed up over a standalone classical circuit. This result is promising due to the superposition characteristic of qubits that are able to compute multiple rays (i.e., for ray tracing) or multiple pixels (i.e., for supersampling) at the same time. However, as the depth of the quantum circuit increases, the noise also increases, especially for non-traversal gates. Thus, decreasing the probability of achieving a correct result, which badly degrades the performance/robustness of the circuit.

The techniques described herein address these and other problems via the implementation of an adaptive quantum instruction scheduler. The adaptive quantum instruction scheduler schedules quantum instructions for execution by multiple quantum parallel processing units (Q-PPUs). The quantum instructions change the circuit depth and reduce quantum logic gate complexity through a novel implementation of quantum teleportation. The resultant quantum circuit operates with reduced noise and increased measurement probability, thereby reducing errors and improving overall reliability of the quantum circuit.

In various implementations, a quantum computing device includes a plurality of Q-PPUs that execute a set of quantum instructions of a quantum application program. The quantum computing device also includes an adaptive quantum instruction scheduler to dynamically distribute the set of quantum instructions to the plurality of Q-PPUs based, at least in part, upon a measured probability of a desired result of executing the set of quantum instructions of the quantum application program and a decoherence time of a qubit.

In some aspects, the techniques described herein relate to a quantum computing device including a plurality of quantum parallel processing units configured to execute a set of quantum instructions of a quantum application program, and an adaptive quantum instruction scheduler configured to dynamically distribute the set of quantum instructions to the plurality of quantum parallel processing units based, at least in part, upon a measured probability of a desired result of executing the set of quantum instructions of the quantum application program and a decoherence time of a qubit.

In some aspects, the techniques described herein relate to a quantum computing device, wherein the plurality of quantum parallel processing units is part of a graphics processing unit.

In some aspects, the techniques described herein relate to a quantum computing device, further including a teleportation unit configured to teleport a first quantum state of a first qubit in a first quantum parallel processing unit of the plurality of quantum parallel processing units to a second qubit in a second quantum parallel processing unit of the plurality of quantum parallel processing units, wherein the decoherence time is a first decoherence time and the qubit is the first qubit, wherein the teleportation unit is configured to teleport the first quantum state of the first qubit to the second qubit at or before expiration of the first decoherence time of the first qubit, and wherein the teleportation unit is configured to teleport a second quantum state of the second qubit in the second quantum parallel processing unit of the plurality of quantum parallel processing units at or before expiration of a second decoherence time of the second qubit.

In some aspects, the techniques described herein relate to a quantum computing device, wherein the adaptive quantum instruction scheduler includes a micro-scheduler that includes micro-scheduling logic configured to distribute the set of quantum instructions for execution by at least the first quantum parallel processing unit and the second quantum parallel processing unit of the plurality of quantum parallel processing units based, at least in part, upon the first decoherence time of the first qubit in the first quantum parallel processing unit and the second decoherence time of the second qubit in the second quantum parallel processing unit.

In some aspects, the techniques described herein relate to a quantum computing device, wherein the adaptive quantum instruction scheduler further includes a macro-scheduler that includes macro-scheduling logic configured to distribute the set of quantum instructions for execution by at least the first quantum parallel processing unit and the second quantum parallel processing unit of the plurality of quantum parallel processing units based, at least in part, upon a comparison of the measured probability to a threshold probability.

In some aspects, the techniques described herein relate to a quantum computing device, wherein, in response to the measured probability being below the threshold probability, the macro-scheduling logic is configured to distribute the set of quantum instructions to the first quantum parallel processing unit to be executed as part of a first set of Grover iterations and to the second quantum parallel processing unit to be executed as part of a second set of Grover iterations.

In some aspects, the techniques described herein relate to a quantum computing device, wherein, after the first set of Grover iterations is executed by the first quantum parallel processing unit of the plurality of quantum parallel processing units, the teleportation unit is configured to teleport the first quantum state of the first qubit in the first quantum parallel processing unit to the second qubit in the second quantum parallel processing unit, causing the second quantum parallel processing unit to execute the second set of Grover iterations.

In some aspects, the techniques described herein relate to a quantum computing device, wherein, after the second set of Grover iterations is executed by the second quantum parallel processing unit, the macro-scheduler is configured to compare a second measured probability to the threshold probability.

In some aspects, the techniques described herein relate to a quantum computing device, wherein, in response to the second measured probability being greater than or equal to the threshold probability, the macro-scheduler is configured to stop distributing the set of quantum instructions.

In some aspects, the techniques described herein relate to a quantum computing device, wherein, in response to the second measured probability being less than the threshold probability, the macro-scheduler is configured to distribute the set of quantum instructions for a selection of Grover iterations to four quantum parallel processing units of the plurality of quantum parallel processing units.

In some aspects, the techniques described herein relate to a system including: a macro-scheduler including macro-scheduling logic configured to distribute a set of quantum instructions of a quantum application program for execution by at least a first quantum parallel processing unit and a second quantum parallel processing unit of a plurality of quantum parallel processing units based, at least in part, upon a comparison of a measured probability of a desired result of executing the set of quantum instructions to a threshold probability, and a micro-scheduler including micro-scheduling logic configured to distribute the set of quantum instructions for execution by at least the first quantum parallel processing unit and the second quantum parallel processing unit of the plurality of quantum parallel processing units based, at least in part, upon a first decoherence time of a first qubit in the first quantum parallel processing unit and a second decoherence time of a second qubit in the second quantum parallel processing unit.

In some aspects, the techniques described herein relate to a system, wherein, in response to the measured probability being below the threshold probability, the macro-scheduling logic is configured to distribute the set of quantum instructions to the first quantum parallel processing unit to be executed as part of a first set of Grover iterations and to the second quantum parallel processing unit to be executed as part of a second set of Grover iterations.

In some aspects, the techniques described herein relate to a system, wherein, after the first set of Grover iterations is executed by the first quantum parallel processing unit of the plurality of quantum parallel processing units, a teleportation unit is configured to teleport a first quantum state of the first qubit in the first quantum parallel processing unit to the second qubit in the second quantum parallel processing unit, causing the second quantum parallel processing unit to execute the second set of Grover iterations.

In some aspects, the techniques described herein relate to a system, wherein, after the second set of Grover iterations is executed by the second quantum parallel processing unit, the macro-scheduling logic is configured to compare a second measured probability to the threshold probability.

In some aspects, the techniques described herein relate to a system, wherein, in response to the second measured probability being greater than or equal to the threshold probability, the macro-scheduling logic is configured to stop.

In some aspects, the techniques described herein relate to a system, wherein, in response to the second measured probability being less than the threshold probability, the macro-scheduling logic is configured to distribute the set of quantum instructions for a selection of Grover iterations to four quantum parallel processing units of the plurality of quantum parallel processing units.

In some aspects, the techniques described herein relate to a method including: distributing, by a macro-scheduler of a quantum computing device including a plurality of quantum parallel processing units, a set of quantum instructions for execution by at least a first quantum parallel processing unit and a second quantum parallel processing unit of the plurality of quantum parallel processing units based, at least in part, upon a comparison of a measured probability to a threshold probability, and distributing, by a micro-scheduler of the quantum computing device, the set of quantum instructions for execution by at least the first quantum parallel processing unit and the second quantum parallel processing unit of the plurality of quantum parallel processing units based, at least in part, upon a first decoherence time of a first qubit in the first quantum parallel processing unit and a second decoherence time of a second qubit in the second quantum parallel processing unit.

In some aspects, the techniques described herein relate to a method, wherein distributing, by the macro-scheduler, the set of quantum instructions for execution by at least the first quantum parallel processing unit and the second quantum parallel processing unit of the plurality of quantum parallel processing units based, at least in part, upon the comparison of the measured probability to the threshold probability includes: in response to the measured probability being below the threshold probability, distributing, by the macro-scheduler, the set of quantum instructions to the first quantum parallel processing unit to be executed as part of a first set of Grover iterations and to the second quantum parallel processing unit to be executed as part of a second set of Grover iterations, and after the second set of Grover iterations is executed by the second quantum parallel processing unit, comparing, by the macro-scheduler, a second measured probability to the threshold probability.

In some aspects, the techniques described herein relate to a method, further including, in response to the second measured probability being less than the threshold probability, distributing, by the macro-scheduler, the set of quantum instructions for a selection of Grover iterations to four quantum parallel processing units of the plurality of quantum parallel processing units.

In some aspects, the techniques described herein relate to a method, wherein the set of quantum instructions include a ray tracing algorithm or a supersampling algorithm.

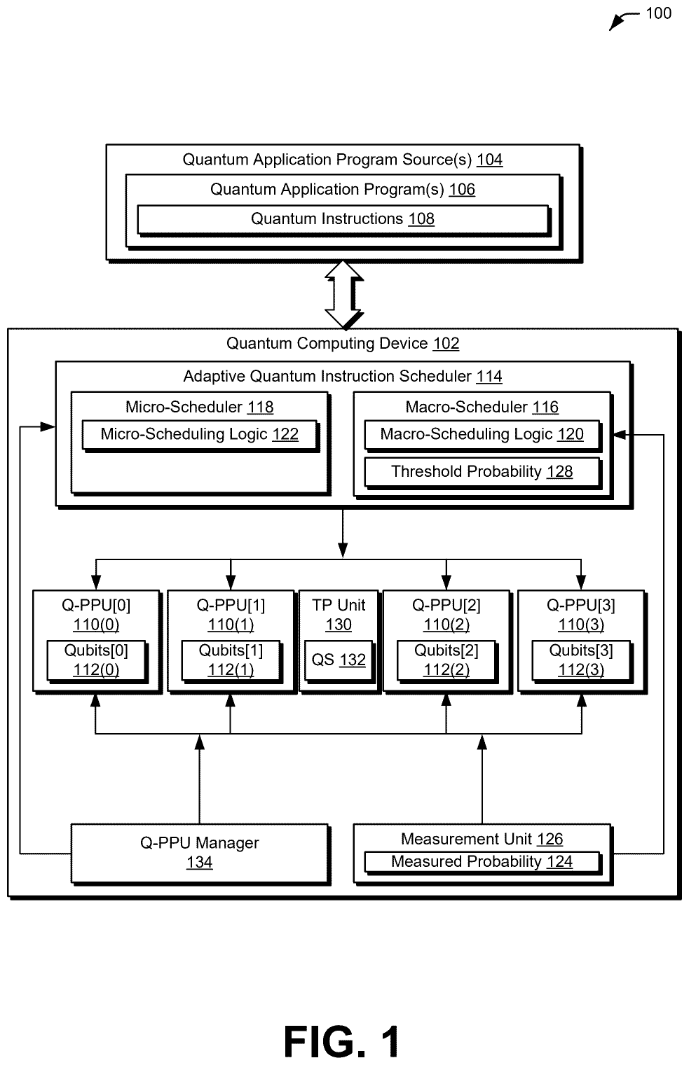

FIG. 1 depicts a non-limiting example operating environment 100 in which an adaptive quantum instruction scheduler distributes quantum instructions to a plurality of Q-PPUs of a quantum computing device. The operating environment 100 includes a quantum computing device 102 operating in communication with one or more quantum application program sources 104 (hereinafter referred to individually as “quantum application program source 104” or collectively as “quantum application program sources 104”) that provide one or more quantum application programs 106 (hereinafter referred to individually as “quantum application program 106” or collectively as “quantum application programs 106”). Each of the quantum application programs 106 includes a set of quantum instructions 108 (shown as “quantum instructions 108”) that are executable by the quantum computing device 102 via a plurality of quantum parallel processing units (Q-PPUs) 110, which each have N qubits 112 of processing power in one or more variations. Thus, each Q-PPU 110 has the processing power comparable to a classical computer having 2^{N} bits.

The quantum computing device 102 is any device that performs computations, at least in part, by manipulating the states of the qubits 112 to execute quantum algorithms to solve problems. For instance, the quantum computing device 102 is a standalone device such as a quantum computer. Alternatively, the quantum computing device 102 is part of another device. For example, the quantum computing device 102 can be a processing component of a quantum computer or a classical computer, the latter of which could be a hybrid computing architecture that has components of both quantum and classical computers. In at least one implementation, the quantum computing device 102 is or part of a central processing unit (CPU). Alternatively or additionally, the quantum computing device 102 is or is part of a graphics processing unit (GPU). Although quantum computers are currently implemented in large climate-controlled environments that are not easily replicated, the techniques disclosed herein are adapted to other form factors akin to those typical of classical computers as quantum computing technology matures. By way of example and not limitation, the quantum computing device 102 is implemented as a traditional desktop, server, laptop, mobile device, vehicle computer, or a part thereof.

The quantum application programming source 104 is any entity that provides the quantum computing device 102 access to the quantum application program 106 so that the quantum computing device 102 executes the quantum instructions 108 to perform quantum tasks, such as, but not limited to, ray tracing and supersampling, according to two example use cases described herein. The quantum application programming source 104 is hardware, software, firmware, or a combination thereof. In some implementations, the quantum application program source 104 is or includes at least a portion of a classical computing system that stores the quantum application program 106. In other implementations, the quantum application programming source 104 is or includes a compiler that compiles source code into the quantum application program 106. In alternative implementations, the quantum application programming source 104 is part of the quantum computing device 102. Thus, in one or more implementations, the quantum application programming source 104 is directly connected to the quantum computing device 102 via an interface, such as a bus interface, a network interface, a wired interface, a wireless (radio) interface, or a combination thereof.

The techniques disclosed herein are applicable to many different types of quantum computing tasks that are accomplished by executing quantum algorithms, such as Grover's search algorithm introduced above. An example discussed herein is directed to applying quantum computing techniques to graphics rendering algorithms, such as ray tracing and supersampling.

The quantum computing tasks are programmed into the quantum application programs 106 using the quantum instructions 108 (also called quantum circuits). The quantum instructions 108 are written in a quantum programming language, some examples of which include, but are not limited to, Python using the Qiskit software development kit and Q #.

The Q-PPUs 110 execute the quantum instructions 108 in parallel. In some implementations, the Q-PPUs 110 are quantum single instruction/multiple data (Q-SIMD) parallel processors that apply a single quantum instruction 108 across multiple data elements. Other types of quantum parallel processors, such as quantum multiple instruction/multiple data (MIMD) parallel processors are adapted to utilize the techniques disclosed herein. Accordingly, the Q-PPUs 110 should not be construed as being limited to any particular parallel processing architecture.

The illustrated quantum computing device 102 also includes an adaptive quantum instruction scheduler 114 that distributes the quantum instructions 108 for execution by the Q-PPUs 110. In one or more implementations, the adaptive quantum instruction scheduler 114 is implemented as part of one or more of the Q-PPUs 110. For example, a specific Q-PPU 110 is configured to distribute the quantum instructions 108 for execution by the other Q-PPUs 110. In other implementations, the adaptive quantum instruction scheduler 114 is implemented as a separate hardware component configured to distribute the quantum instructions 108 for execution by the Q-PPUs 110. In some implementations, the adaptive quantum instruction scheduler 114 is or includes a separate quantum circuit that includes one or more quantum gates configured to receive or otherwise obtain the quantum instructions 108 from the quantum application programming source 104 and distribute the quantum instructions 108 to one or more of the Q-PPUs 110 for execution.

In one or more implementations, the adaptive quantum instruction scheduler 114 includes a macro-scheduler 116 and a micro-scheduler 118. In one or more implementations, the macro-scheduler 116 and/or the micro-scheduler 118 is/are implemented as part of one or more of the Q-PPUs 110. In other implementations, the macro-scheduler 116 and/or the micro-scheduler 118 is/are implemented as one or more separate hardware components configured to distribute the quantum instructions 108 for execution by the Q-PPUs 110. In some implementations, the macro-scheduler 116 and the micro-scheduler 118 include one or more quantum gates configured to receive or otherwise obtain the quantum instructions 108 from the quantum application programming source 104 and distribute the quantum instructions 108 to one or more of the Q-PPUs 110 for execution.

The macro-scheduler 116 distributes the quantum instructions 108 to be executed by the Q-PPUs 110 in a coarse-grained way in accordance with macro-scheduling logic 120. The macro-scheduling logic 120, in one or more implementations, includes a set of instructions configured to be executed by the macro-scheduler 116 (e.g., implemented on one of the Q-PPUs 110 or a separate hardware component). In other implementations, the macro-scheduling logic 120 is or includes one or more quantum gates configured to distribute the quantum instructions 108 to be executed by the Q-PPUs 110 in a coarse-grained way.

The micro-scheduler 118 distributes the quantum instructions 108 to be executed by the Q-PPUs 110 in a fine-grained way in accordance with the micro-scheduling logic 122. The micro-scheduling logic 120, in one or more implementations, includes a set of instructions configured to be executed by the micro-scheduler 118. (e.g., implemented on one of the Q-PPUs 110 or a separate hardware component). In other implementations, the macro-scheduling logic 120 is or includes one or more quantum gates configured to distribute the quantum instructions 108 to be executed by the Q-PPUs 110 in a coarse-grained way.

Prior to describing, in detail, the functionality of the adaptive quantum instruction scheduler 114, a brief description of an iteration of Grover's algorithm (referred to herein as a “Grover iteration”) will be provided for context. Grover's algorithm generally includes an initialization step, an oracle step, an amplitude amplification step, and a measurement step. A Grover iteration is a single cycle of the oracle and amplitude amplification steps of Grover's algorithm.

In the initialization step, the N qubits 112 of a corresponding Q-PPU 110 are in a superposition of all possible binary states. For example, if N=4, a Q-PPU 110 has four qubits 112, which are labeled q[0], q[1], q[2], and q[3] and are used to represent the quantum state during execution of Grover's algorithm. The initial state is a superposition of all possible states, which is achieved through a Hadamard transform (H gate) applied to each of the four qubits 112. The Hadamard transform creates a superposition of all possible states for each qubit 112. After applying the Hadamard transform, the four qubits 112 are in an equal superposition of all possible binary states. This superposition represents the initial state of the quantum register for Grover's algorithm.

After the initialization step, an oracle operator is applied to mark the solution(s) in the superposition. The oracle operator flips the phase of the state corresponding to the solution(s) while leaving the other states unchanged. This step utilizes prior knowledge of the problem and is responsible for encoding the search criterion into the quantum state.

After the oracle operator is applied, the amplitude amplification step is performed. In particular, a reflection operator known as the Grover diffusion operator is applied. This operator reflects the amplitudes around the average, which increases the amplitude of the marked solution(s) while decreasing the amplitude of the other states. The Grover diffusion operator performs two steps. First, the average amplitude is calculated, and the amplitudes are reflected around this average value. Second, the sign of each amplitude is negated, which creates constructive interference for the marked solution(s) and destructive interference for the other states. The oracle and amplitude amplification steps are then repeated a certain number of times (i.e., a certain number of Grover iterations).

After the Grover iterations, a measurement on the qubits 112 is performed. The marked solution(s) will have a higher probability of being measured compared to the other states. By repeating the oracle and amplitude amplification steps, Grover's algorithm concentrates the probability amplitudes onto the marked solution(s), allowing for efficient searching. The algorithm's advantages are in the quantum superposition and interference effects that enable the simultaneous evaluation of multiple states and constructive or destructive interference to enhance or suppress certain outcomes.

Given the context provided by the above description of Grover's algorithm, the macro-scheduling logic 120 executed by the macro-scheduler 116 will be described. For M number of Q-PPUs 110, each having N qubits 112, N number of Grover iterations are performed on the quantum instructions 108 of the quantum application program 106. For example, a Q-PPU 110 having 4 qubits (i.e., N=4) 112 performs four Grover iterations on the quantum application program 106. The macro-scheduler 116 dynamically distributes the quantum instructions 108 to the Q-PPUs 110 by mapping the N number of Grover iterations to the M number of Q-PPUs 110 according to a measured probability 124 received from a measurement unit 126.

The measurement unit 126 measures the qubits 112 to determine a probability (i.e., the measured probability 124) of finding a target item (i.e., a marked solution) after a certain number of Grover iterations. In each Grover iteration, the probability of measuring the target item increases, and after a certain number of iterations, the probability approaches a maximum value. The precise number of Grover iterations implemented to achieve a high probability of success depends on the size of the search space, such as the M number of Q-PPUs 110 in this case. Thus, the measured probability 124 is the likelihood of measuring the target item correctly after a specific number of Grover iterations. The measured probability 124 increases as the number of Grover iterations increases, eventually approaching a maximum value that depends on the size of the search space.

If the measured probability 124 is less than a threshold probability 128, then the macro-scheduler 116 distributes the quantum instructions 108 for Grover iteration 0 to iteration

$$n = \frac{N}{2}$$

to Q-PPU[0] 110(0), and then distributes the quantum instructions 108 for Grover iteration n+1 to N−1 to Q-PPU[1] 110(1).

After the Q-PPU[0] 110(0) executes the quantum instructions 108, a teleportation unit 130 (shown as “TP unit 130”) teleports one or more quantum states 132 (shown generally as “QS”) of each of the N qubits[0] 112(0) from the Q-PPU[0] 110(0) to the Q-PPU[1] 110(1). The teleportation unit 130 is a device that uses a set of quantum gates and the concept of quantum entanglement to enable the transfer of quantum information from one qubit 112 to another (such as from the qubit [0] 112(0) to the qubit [1] 112(1) in this example), without physically moving the qubit 112 itself. The Q-PPU[1] 110(1) then executes the other half of the N number of Grover iterations of the quantum instructions 108. The macro-scheduling logic 120 increases the probability that measuring the final qubits yields the desired result. Since each Q-PPU 110 uses half of the computation time, the stability of the qubits 112 is doubled with a relatively longer decoherence time.

After the Q-PPU[1] 110(1) executes the quantum instructions 108, the measurement unit 126 performs another measurement step to determine the measured probability 124. The measured probability 124 is compared against the threshold probability 128. If the measured probability 124 is greater than or equal to the threshold probability 128, then the macro-scheduler 116 stops the macro-scheduling logic 120. Otherwise, the macro-scheduler 116 selects two Grover iterations,

$$\frac{N}{2} and \frac{( n + N )}{2} ,$$

and distributes the quantum instructions 108 for the selected Grover iterations to four Q-PPUs 110. For example, the macro-scheduler 116 distributes the quantum instructions 108 for Grover iterations 0 to N/2 to the Q-PPU[0] 110(0); the macro-scheduler 116 distributes the quantum instructions 108 for Grover iterations N/2 to n to Q-PPU[1] 110(1); the macro-scheduler 116 distributes the quantum instructions 108 for iterations n to

$$\frac{( n + N )}{2}$$

to the Q-PPU[2] 110(2); and the macro-scheduler 116 distributes the quantum n to instructions 108 for Grover iterations

$$\frac{( n + N )}{2}$$

to N−1 to the Q-PPU[3] 110(3). This scheduling action of the macro-scheduler logic 120 quadruples the probability that measuring the final qubits yields the desired result. Since each Q-PPU 110 uses a quarter of the computation time, the stability of the qubits 112 is quadrupled with a relatively longer decoherence time. This scheduling action of the macro-scheduler logic 120 is repeated until the measured probability 124 is greater than or equal to the threshold probability 128.

The macro-scheduler 116 is also used when an oracle function of a Grover iteration is relatively long, such is the case for ray tracing. In this case, each Grover iteration includes multiple tracing steps defined as part of the quantum instructions 108. When a ray hits an object, more rays are generated, and each ray hits a different object and so on until the maximum depth is reached. This recursive characteristic of ray tracing therefore utilizes a relatively long oracle function to include multiple ray generation/intersection steps.

In one non-limiting example, for a depth of ray tracing D, each Grover iteration includes the following steps:
(1) RayGen—generate rays in a hemisphere and store the rays in a superposition;
(2) TraceRay—trace the rays in each direction;
(3) IntersectRay—find the intersection point among the primitives and the rays;
(4) CalColor—calculate the color based on the intersection point among the primitives and the rays; and
(5) UnCompute—reverse intermediate computations to restore the ancillary qubits states.

For example, on the Q-PPU[0] 110(0), which is already assigned the Grover iteration 0, the macro-scheduler 116 checks the current tracing depth d, and if d==D−1, then no action is taken. Otherwise, the macro-scheduler 116 distributes the Grover iteration steps as discussed above to a free Q-PPU[1] 110(1) and increases the current tracing depth d.

When the step CalColor is completed, the macro-scheduler 116 instructs the teleportation unit 130 to teleport the quantum states 132 of the qubits 112 to the Q-PPU[1] 110(1) and trigger the Grover iteration to repeat at the Q-PPU[1] 110(1). In one or more implementations, this procedure is repeated until the depth D is reached on Q-PPU[D−1] (not shown).

After the Q-PPU[D−1] executes the quantum application program 106, the macro-scheduler 116 compares the measured probability 124 against the threshold probability 128. If the measured probability 124 is greater than or equal to the threshold probability 128, then the macro-scheduler 116 stops the scheduling action. Otherwise, the macro-scheduler 116, via execution of the macro-scheduling logic 120, divides the Grover iteration into two parts: RayGen and TraceRay steps, and IntersectRay and CalColor steps.

The macro-scheduler 116 distributes the IntersectRay and CalColor steps to a free Q-PPU, such as the Q-PPU[0] 110(0) and distributes the RayGen and TraceRay to another free Q-PPU, such as the Q-PPU[1] 110(1). When the step TraceRay is completed on the Q-PPU[0] 110(0), the macro-scheduler 116 instructs the teleportation unit 130 to teleport the quantum states 132 of the qubits[0] 112(0) in the Q-PPU[0] 110(0) to the qubits[1] 112(1) in the Q-PPU[1] 110(1), triggers execution of the RayGen step by the Q-PPU[1] 110(1), and increases the depth counter d. This procedure is repeated until the depth D is reached on the Q-PPU[2D-1] (not shown).

After the Q-PPU[2D-1] executes the quantum application program 106, the macro-scheduler 116 compares the measured probability 124 against the threshold probability 128. If the measured probability 124 is greater than or equal to the threshold probability 128, then the macro-scheduler 116 stops the scheduling action. Otherwise, the macro-scheduler 116 continues with the next Grover iteration.

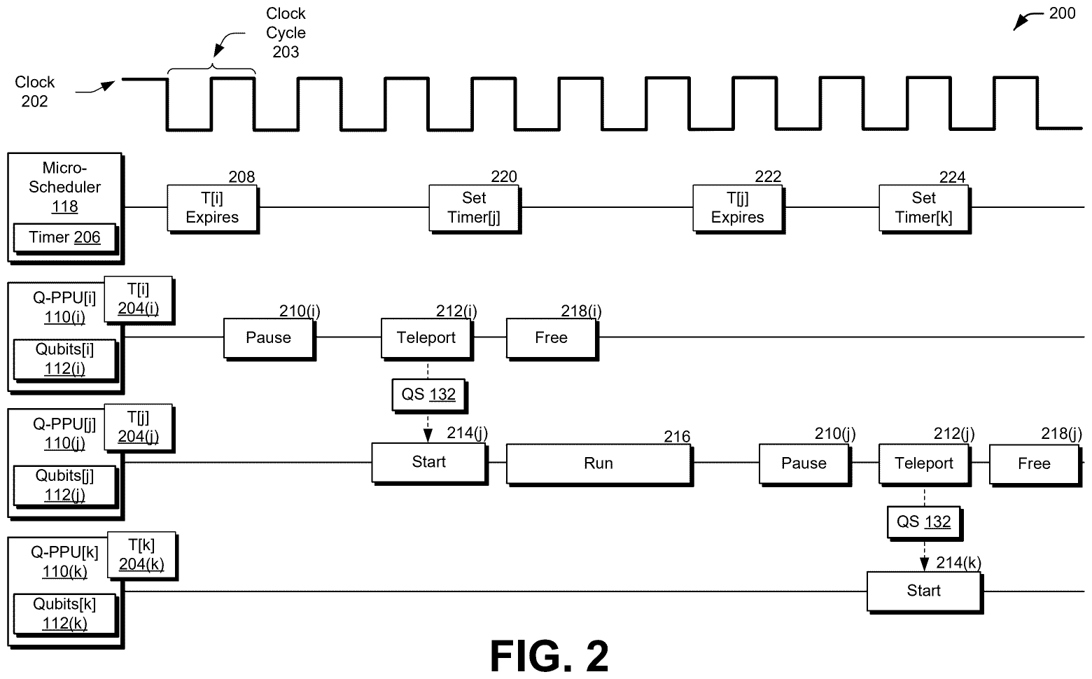

In accordance with the described techniques, the micro-scheduler 118 is a last level scheduler to improve the reliability of a quantum circuit to allow quantum computing tasks to be performed within the stable lifetimes of the qubits 112. In one or more implementations, the micro-scheduler 118 schedules the quantum instructions 108 to be executed by the Q-PPUs 110 in a fine-grained way in accordance with the micro-scheduling logic 122. Additional details about the micro-scheduler 118 will be described with reference to FIG. 2.

The quantum computing device 102 also includes a Q-PPU manager 134. The Q-PPU manager 134 monitors the status of the Q-PPUs 110 and informs the adaptive quantum instruction scheduler 114 when one or more of the Q-PPUs 110 is/are available to process additional quantum instructions 108.

FIG. 2 depicts a non-limiting example micro-scheduler sequence 200 performed by the micro-scheduler 118 of the adaptive quantum instruction scheduler 114 in accordance with an implementation of the micro-scheduling logic 122. The micro-scheduler sequence 200 follows a clock 202, which has multiple clock cycles 203 as shown. The clock 202 and the clock cycles 203 are not intended to directly align with the various operations described as part of the micro-scheduler sequence 200. As such, the clock 202 and the clock cycles 203 should not be construed as being limiting in any way, and particularly with respect to when the various operations are performed.

The micro-scheduler 118 distributes the quantum instructions 108 to multiple Q-PPUs 110 based upon a timer 206. The qubits 112 of the Q-PPUs 110 are associated with decoherence times T 204, which are represented as a specific number of clock cycles 203 of the clock 202. In the illustrated example, the qubits 112 of different Q-PPUs 110 have different decoherence times T 204. The qubits 112 remain stable until expiration of the corresponding decoherence time T 204. The micro-scheduler 118 uses the timer 206 to keep track of the current time. At or before expiration of a decoherence time T 204, the micro-scheduler 118 pauses the execution of the quantum instructions 108 at the corresponding Q-PPU 110 and distributes the remaining quantum instructions 108 to an available Q-PPU 110. Meanwhile, the teleportation unit 130 teleports the quantum states 132 of the qubits 112 to the available Q-PPU 110.

As a detailed example, for instance, consider the following discussion. The qubits[i] 112(i) of the Q-PPU(i) 110(i) are associated with a decoherence time T[i] 204(i), the qubits[j] 112(j) of the Q-PPU(j) 110(j) are associated with a decoherence time T[j] 204(j), and the qubits[k] 112(k) of the Q-PPU(k) 110(k) are associated with a decoherence time T[k] 204(k). At or before expiration of the decoherence time T[i] 204(i) (shown as “T[i] expires 208”), the micro-scheduler 118 pauses (shown as “pause 210 (i)”) the execution of the quantum instructions 108 at the Q-PPU[i] 110(i) (e.g., execution of one or more steps of a Grover iteration) and distributes the remaining quantum instructions 108 to an available Q-PPU 110, such as Q-PPU[j] (j) in the illustrated example. The teleportation unit 130 teleports the quantum states 132 of the qubits[i] 112(i) to the qubits[j] 112(j) of the Q-PPU[j] 110(j). The Q-PPU[j] 110(j) then starts (shown as “start 214 (j)”) executing the quantum instructions 108 (shown as “run 216”). Meanwhile, the Q-PPU[i] 110(i) becomes available (shown as “free 218 (i)”) for processing other quantum instructions 108.

The micro-scheduler 118 also sets the timer 206 (shown as “set Timer [j] 220”) for the expiration of the decoherence time T[j] 204(j) associated with the Q-PPU[i] 110(j). At or before expiration of the decoherence time T[j] 204(i) (shown as “T[j] expires 222”), the micro-scheduler 118 pauses (shown as “pause 210 (j)”) the execution of the quantum instructions 108 at the Q-PPU[i] 110(i) (e.g., execution of one or more steps of a Grover iteration) and distributes the remaining quantum instructions 108 to an available Q-PPU 110, such as Q-PPU[k] (k) in the illustrated example. The teleportation unit 130 teleports the quantum states 132 of the qubits[j] 112(j) to the qubits[k] 112(k) of the Q-PPU[k] 110(k). The Q-PPU[k] 110(k) then starts (shown as “start 214 (k)”) executing the quantum instructions 108. Meanwhile, the Q-PPU[j] 110(j) becomes available (shown as “free 218 (j)”) for processing other quantum instructions 108.

The micro-scheduler 118 also sets the timer 206 (shown as “set Timer [k] 224”) for the expiration of the decoherence time T[k] 204(k) associated with the Q-PPU[k] 110(k). The micro-scheduler 118 repeats the micro-scheduling logic 122 described above until there are no free Q-PPUs 110 or the instruction execution time on Q-PPU[i] 110(i) is less than the decoherence time T[i] 204(i).

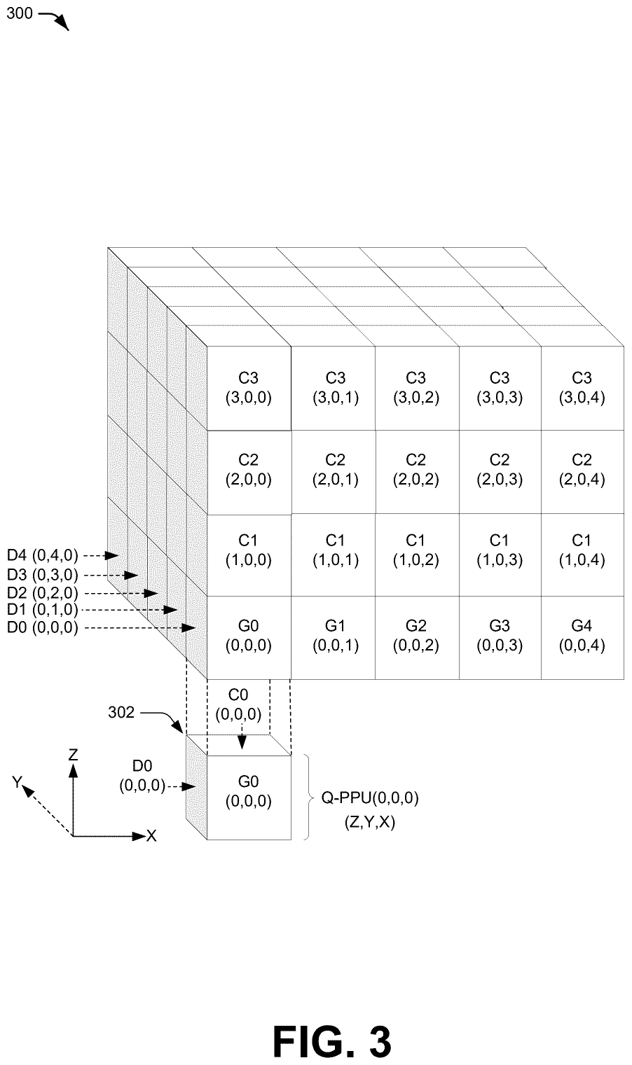

FIG. 3 depicts a Q-PPU grid 300 as a non-limiting example logical configuration of the plurality of Q-PPUs 110 of the quantum computing device 102. The Q-PPUs 110 described above can be organized in various ways. The illustrated Q-PPU grid 300 is one way the Q-PPUs 110 can be indexed in three dimensions. Visual representations of the Q-PPUs 110 are shown as cubes that form the Q-PPU grid 300. These visual representations are referred to herein collectively as Q-PPU items 302, each of which is associated with values for the Z-axis, Y-axis, and X-axis. For example, one Q-PPU item 302 associated with Z=0, Y=0, and X=0 is shown apart from the Q-PPU grid 300.

The macro-scheduler 116 distributes the Grover iterations (G) along the X-axis: G0 to Q-PPU(0,0,0), G1 to Q-PPU(0,0,1), G2 to Q-PPU(0,0,2), and so on. The macro-scheduler 116 also divides a single Grover iteration along the Y-axis for long iteration cases, such as is the case for ray tracing, with trace depth (D): DO to Q-PPU(0,0,0), D1 to Q-PPU(0,1,0), D2 to Q-PPU(0,2,0), and so on. The micro-scheduler 118 distributes groups of instructions as clauses (C) within the quantum decoherence time T 204 along the Z-axis: C0 to Q-PPU(0,0,0), C1 to Q-PPU(1,0,0), C2 to Q-PPU(2,0,0), and so on.

The illustrated Q-PPU grid 300 with each Q-PPU item 302 having (Z,Y,X) dimensions is one example logical configuration. In practice, the actual physical numbers are far less than Z*Y*X because the Q-PPU items 302 are scheduled off quickly and return to a free/available state (such as shown as “free 218” in FIG. 2) before being scheduled again to be reused. The Q-PPU manager 134 recycles the Q-PPU items 302 and reports to the macro-scheduler 116 and the micro-scheduler 118 as the Q-PPU items 302 become available. The macro-scheduler 116 and the micro-scheduler 118 reschedules the available Q-PPU items 302.

In an example execution sequence (not shown) starting from Q-PPU(0,0,0) and ending at Q-PPU(3,4,4), each Q-PPU item 302 executes a portion of the quantum instructions 108. The execution time is short enough to keep the qubits 112 in a stable state. In this manner, a higher probability of measuring the desired final results is achieved.

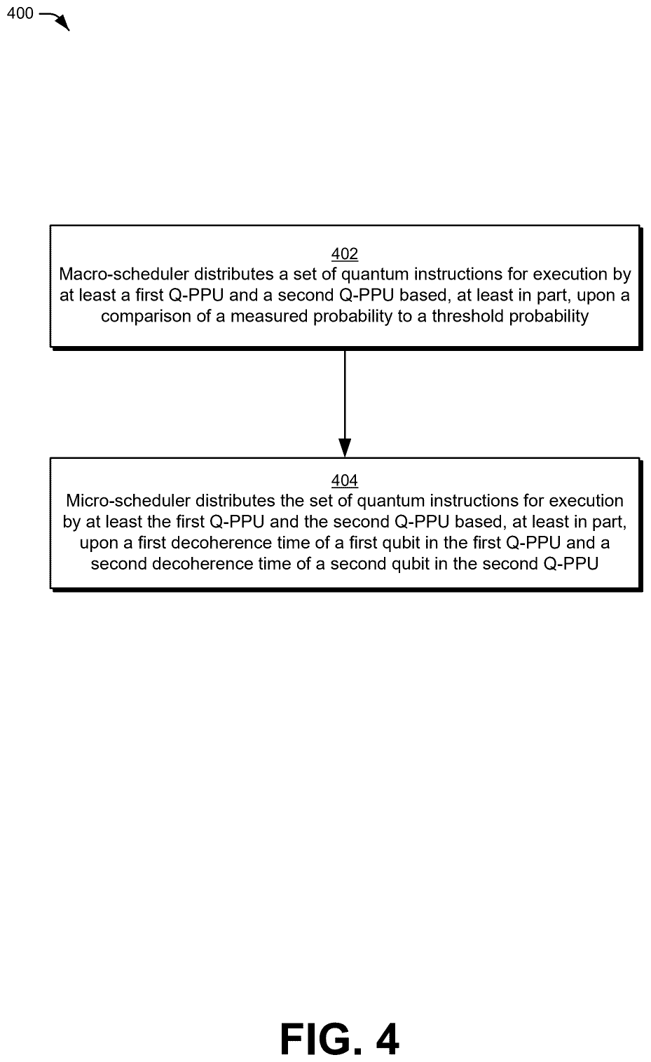

FIG. 4 depicts a method 400 for scheduling quantum instructions 108 in a course-grained way by the macro-scheduler 116 of the adaptive quantum instruction scheduler 114 and in a fine-grained way by the micro-scheduler 118 of the adaptive quantum instruction scheduler 114.

The method 400 is described with reference to FIG. 4 and additional reference to FIG. 1 and FIG. 2. The method 400 begins and proceeds to operation 402. At operation 402, the macro-scheduler 116 distributes a set of quantum instructions 108 for execution by at least a first Q-PPU, such as the Q-PPU[0] 110(0), and a second Q-PPU, such as the Q-PPU[1] 110(1), based, at least in part, upon a comparison of a measured probability 124 to a threshold probability 128. For example, in response to the measured probability 124 being below the threshold probability 128, the macro-scheduler 116 distributes the set of quantum instructions 108 to the Q-PPU[0] 110(0) to be executed as part of a first set of Grover iterations and to the Q-PPU[1] 110(1) to be executed as part of a second set of Grover iterations.

After the first set of Grover iterations is executed by Q-PPU[0] 110(0), the teleportation unit 130 teleports a first quantum state 132(0) of a first qubit 112(0) in the Q-PPU[1] 110(1) to a second qubit 112(1) in the Q-PPU[1] 110(1), causing the Q-PPU[1] 110(1) to execute the second set of Grover iterations. In this manner, the measured probability 124 doubles because each Q-PPU 110 uses half of the computation time. This reduction in computation time doubles the stability of the qubits 112 with a relatively longer decoherence time.

After the second set of Grover iterations is executed by the Q-PPU[1] 110(1), the macro-scheduler 116 compares a second measured probability 124 to the threshold probability 128. In response to the second measured probability 124 being greater than or equal to the threshold probability 128, the macro-scheduler 116 stops. Alternatively, in response to the second measured probability 124 being less than the threshold probability 128, the macro-scheduler 116 distributes the set of quantum instructions 108 for a selection of Grover iterations to four Q-PPUs, such as the Q-PPU[0] 110(0), the Q-PPU[1] 110(1), the Q-PPU[2] 110(2), and the Q-PPU[3] 110(3). In this manner, the measured probability 124 quadruples because each Q-PPU 110 uses a quarter of the computation time. This reduction in computation time quadruples the stability of the qubits 112 with a relatively longer decoherence time. The scheduling logic can repeat until the measured probability 124 is greater than or equal to the threshold probability 128.

From operation 402, the method 400 proceeds to operation 404. At operation 404, the micro-scheduler 118 distributes the set of quantum instructions 108 for execution by at least a first Q-PPU (e.g., the Q-PPU[0] 110(0)) and a second Q-PPU (e.g., the Q-PPU[1] 110(1)) based, at least in part, upon a first decoherence time T[0] 204[0] of the first qubit 112(0) in the Q-PPU[0] 110(0) and a second decoherence time T[1] 204(1) of the second qubit 112(1) in the Q-PPU[1] 110(1). For example, if a time value (i.e., in clock cycles 203) is less than a decoherence time, then the qubits 112 associated with that decoherence time remain stable. For this reason, at or before expiration of the decoherence time T[0] 204(0), the micro-scheduler 118 pauses the quantum instruction 108 execution in the Q-PPU[0] 110(0) (e.g., execution of one or more steps of a Grover iteration) and distributes the remaining quantum instructions 108 to an available Q-PPU 110, such as Q-PPU[1](1) in this example. The teleportation unit 130 teleports the quantum state 132 of the qubit [0]112(0) to the qubit [1] 112(1) of the Q-PPU[1] 110(1) in this example. The Q-PPU[1] 110(1) then starts executing the quantum instructions 108. Meanwhile, the Q-PPU[0] 110(0) becomes available for processing other quantum instructions 108. The micro-scheduler 118 establishes a timer 206 for the expiration of each of the decoherence times T[0] 204(0) and T[1] 204(1) in this example. The micro-scheduling logic 120 repeats until there are no more available Q-PPUs 110 or the instruction execution time on the Q-PPU[i] 110(i) is less than the decoherence time T[i] 204(i) of the qubit(s) 112(i).

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the quantum computing device 102, the quantum application programming source(s) 104, the adaptive quantum instruction scheduler 114, the micro-scheduler 1118, the macro-scheduler 116, the Q-PPUs 110, the measurement unit 126, and the Q-PPU manager 134) are implemented in any of a variety of different manners such as hardware circuitry, software or firmware executing on a programmable processor, or any combination of two or more of hardware, software, and firmware. The method provided is implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a quantum computer, a hybrid quantum/classical computer, and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A quantum computing device comprising:
a plurality of quantum parallel processing units configured to execute a set of quantum instructions of a quantum application program; and
an adaptive quantum instruction scheduler configured to dynamically distribute the set of quantum instructions to the plurality of quantum parallel processing units based, at least in part, upon a measured probability of a desired result of executing the set of quantum instructions of the quantum application program and a decoherence time of a qubit.

2. The quantum computing device of claim 1, wherein the plurality of quantum parallel processing units is part of a graphics processing unit.

3. The quantum computing device of claim 1, further comprising a teleportation unit configured to teleport a first quantum state of a first qubit in a first quantum parallel processing unit of the plurality of quantum parallel processing units to a second qubit in a second quantum parallel processing unit of the plurality of quantum parallel processing units, wherein the decoherence time is a first decoherence time and the qubit is the first qubit, wherein the teleportation unit is configured to teleport the first quantum state of the first qubit to the second qubit at or before expiration of the first decoherence time of the first qubit, and wherein the teleportation unit is configured to teleport a second quantum state of the second qubit in the second quantum parallel processing unit of the plurality of quantum parallel processing units at or before expiration of a second decoherence time of the second qubit.

4. The quantum computing device of claim 3, wherein the adaptive quantum instruction scheduler comprises a micro-scheduler that includes micro-scheduling logic configured to distribute the set of quantum instructions for execution by at least the first quantum parallel processing unit and the second quantum parallel processing unit of the plurality of quantum parallel processing units based, at least in part, upon the first decoherence time of the first qubit in the first quantum parallel processing unit and the second decoherence time of the second qubit in the second quantum parallel processing unit.

5. The quantum computing device of claim 4, wherein the adaptive quantum instruction scheduler further comprises a macro-scheduler that includes macro-scheduling logic configured to distribute the set of quantum instructions for execution by at least the first quantum parallel processing unit and the second quantum parallel processing unit of the plurality of quantum parallel processing units based, at least in part, upon a comparison of the measured probability to a threshold probability.

6. The quantum computing device of claim 5, wherein, in response to the measured probability being below the threshold probability, the macro-scheduling logic is configured to distribute the set of quantum instructions to the first quantum parallel processing unit to be executed as part of a first set of Grover iterations and to the second quantum parallel processing unit to be executed as part of a second set of Grover iterations.

7. The quantum computing device of claim 6, wherein, after the first set of Grover iterations is executed by the first quantum parallel processing unit of the plurality of quantum parallel processing units, the teleportation unit is configured to teleport the first quantum state of the first qubit in the first quantum parallel processing unit to the second qubit in the second quantum parallel processing unit, causing the second quantum parallel processing unit to execute the second set of Grover iterations.

8. The quantum computing device of claim 7, wherein, after the second set of Grover iterations is executed by the second quantum parallel processing unit, the macro-scheduler is configured to compare a second measured probability to the threshold probability.

9. The quantum computing device of claim 8, wherein, in response to the second measured probability being greater than or equal to the threshold probability, the macro-scheduler is configured to stop distributing the set of quantum instructions.

10. The quantum computing device of claim 8, wherein, in response to the second measured probability being less than the threshold probability, the macro-scheduler is configured to distribute the set of quantum instructions for a selection of Grover iterations to four quantum parallel processing units of the plurality of quantum parallel processing units.

11. A system comprising:
a macro-scheduler comprising macro-scheduling logic configured to distribute a set of quantum instructions of a quantum application program for execution by at least a first quantum parallel processing unit and a second quantum parallel processing unit of a plurality of quantum parallel processing units based, at least in part, upon a comparison of a measured probability of a desired result of executing the set of quantum instructions to a threshold probability; and
a micro-scheduler comprising micro-scheduling logic configured to distribute the set of quantum instructions for execution by at least the first quantum parallel processing unit and the second quantum parallel processing unit of the plurality of quantum parallel processing units based, at least in part, upon a first decoherence time of a first qubit in the first quantum parallel processing unit and a second decoherence time of a second qubit in the second quantum parallel processing unit.

12. The system of claim 11, wherein, in response to the measured probability being below the threshold probability, the macro-scheduling logic is configured to distribute the set of quantum instructions to the first quantum parallel processing unit to be executed as part of a first set of Grover iterations and to the second quantum parallel processing unit to be executed as part of a second set of Grover iterations.

13. The system of claim 12, wherein, after the first set of Grover iterations is executed by the first quantum parallel processing unit of the plurality of quantum parallel processing units, a teleportation unit is configured to teleport a first quantum state of the first qubit in the first quantum parallel processing unit to the second qubit in the second quantum parallel processing unit, causing the second quantum parallel processing unit to execute the second set of Grover iterations.

14. The system of claim 13, wherein, after the second set of Grover iterations is executed by the second quantum parallel processing unit, the macro-scheduling logic is configured to compare a second measured probability to the threshold probability.

15. The system of claim 14, wherein, in response to the second measured probability being greater than or equal to the threshold probability, the macro-scheduling logic is configured to stop.

16. The system of claim 14, wherein, in response to the second measured probability being less than the threshold probability, the macro-scheduling logic is configured to distribute the set of quantum instructions for a selection of Grover iterations to four quantum parallel processing units of the plurality of quantum parallel processing units.

17. A method comprising:
distributing, by a macro-scheduler of a quantum computing device comprising a plurality of quantum parallel processing units, a set of quantum instructions for execution by at least a first quantum parallel processing unit and a second quantum parallel processing unit of the plurality of quantum parallel processing units based, at least in part, upon a comparison of a measured probability to a threshold probability; and
distributing, by a micro-scheduler of the quantum computing device, the set of quantum instructions for execution by at least the first quantum parallel processing unit and the second quantum parallel processing unit of the plurality of quantum parallel processing units based, at least in part, upon a first decoherence time of a first qubit in the first quantum parallel processing unit and a second decoherence time of a second qubit in the second quantum parallel processing unit.

18. The method of claim 17, wherein distributing, by the macro-scheduler, the set of quantum instructions for execution by at least the first quantum parallel processing unit and the second quantum parallel processing unit of the plurality of quantum parallel processing units based, at least in part, upon the comparison of the measured probability to the threshold probability comprises:
in response to the measured probability being below the threshold probability, distributing, by the macro-scheduler, the set of quantum instructions to the first quantum parallel processing unit to be executed as part of a first set of Grover iterations and to the second quantum parallel processing unit to be executed as part of a second set of Grover iterations; and
after the second set of Grover iterations is executed by the second quantum parallel processing unit, comparing, by the macro-scheduler, a second measured probability to the threshold probability.

19. The method of claim 18, further comprising, in response to the second measured probability being less than the threshold probability, distributing, by the macro-scheduler, the set of quantum instructions for a selection of Grover iterations to four quantum parallel processing units of the plurality of quantum parallel processing units.

20. The method of claim 17, wherein the set of quantum instructions comprise a ray tracing algorithm or a supersampling algorithm.
